(19) United States
(12) Patent Application Publication
(10) Pub. No.: US 2004/0025970 A1
(43) Pub. Date: Feb. 12, 2004

(54) Method for more efficient use of trees twelve inches or less in diameter

(76) Inventor: Peter Sing, McCleary, WA (US)

Correspondence Address: PETER SING, P.O. BOX 1691, MCCLEARLY, WA, 98557, US

(21) Appl. No.: 10/213,988

(22) Filed: Aug. 7, 2002

(51) Int. Cl. B27F 1/00; B27F 5/00

(52) U.S. Cl. 144/345

(57) ABSTRACT

The steps of the subject method are (1) cutting fallen trees into segments, (2) cutting portions off each segment to create two flat, parallel surfaces, called flats, to produce a cant from each segment, (3) sawing at least one lengthwise radial slit in each cant, (4) kiln drying the cants, (5) filling each slit partially or fully with material having qualities similar to the qualities of the cants, (6) selecting pluralities of cants, each plurality being comprised of cants differing in diameter no more than a designated amount, the amount being in a range of 0 to 2 inches, (7) selecting at least two cants from one of the pluralities, (8) joining at least two cants flat-to-flat. One of the least two cants may be sawed in half lengthwise with the cut parallel to the flats and then the half cants are glued to the other cant flats-to-flats. Any and all of steps 3, 4 and 5 may be omitted.

### BACKGROUND OF THE INVENTION

1. Field

The subject invention is in the field of harvesting and milling trees, particularly smaller diameter trees such as those harvested in the thinning of trees on tree farms. Still more particularly it is in this field as applied to trees twelve inches or less in diameter. The increasing demand for timber products and the diminishing supply are making it feasible and necessary to make use of all available trees.

2. Prior Art

U.S. Pat. Nos. 5,485,794, 5,618,371, 5,865,929, 5,896,723, RE 35.327 and RE 36.153 are all related to the field of more efficient use of trees and are issued to the inventor of the subject invention. In practicing these inventions, experience has shown that there are more efficient techniques than those patented for efficient use of trees twelve inches or less in diameter and particularly for trees seven inches or less in diameter. The efficiency is manifested by the production of end products to particular standards of quality and quantity using less time and energy and with less wastage of new products. Accordingly, the objective of the subject invention Is to provide a method for more efficient use of trees twelve inches or less in diameter, the method specifically being lower labor intensive and requiring fewer planing, slitting, sawing and gluing steps to produce high quality end products.

### SUMMARY OF THE INVENTION

The subject invention is a method for more efficient use of trees twelve inches or less in diameter. Very briefly the method comprises the steps of:

1. Cutting fallen logs into segments of appropriate lengths;

2. Removing material from each segment to provide parallel flat surfaces called flats having widths in a range of ¼ to ¾ of the diameter of the segment, producing a part called a cant;

3. Sawing at least one lengthwise, radial slit in each cant with slit depth in a range of ⅛ to ⅜ of the diameter of the cant, 8 slits being preferred;

4. Kiln drying the cants;

5. Filling at least portions of the slits with material having qualities similar to the qualities of the cants;

6. Selecting pluralities of cants, each plurality being comprised of cants having diameters differing no more than a designated amount, said amount being in a range of 0 to 2 inches;

7. Joining at least two cants from one plurality together, flat-to-flat, leaving at least one unjoined flat;

The joined cants can be sawed into various pieces to produce end products such as flat boards and beams.

Before all gluing operations it may be deemed advisable to plane the surfaces to be glued to each other, since the flat surfaces produced by the planing enable better gluing strength.

The invention is described in more detail below with reference to the attached drawings.

### BRIEF DESCRIPTION OF THE DRAWINGS

FIG. 1 illustrates a cant, having two flats.

FIG. 2 illustrates a cant slit to relieve tension and warping.

FIG. 3 illustrates a cant with one slit, the slit partially refilled.

FIG. 4 illustrates a plurality of cants, glued together flat-to-flat, producing an end product;

FIG. 5 is an exploded view illustrating 4 beams cut from the end product.

FIG. 6 illustrates two planks cut from the end product.

FIG. 7 illustrates a tongue and groove board made of three of the planks shown in FIG. 6.

### DETAILED DESCRIPTION OF THE INVENTION

The subject invention is a method for more efficient use of trees twelve inches or less in diameter. The method comprises the steps of:

1. cutting fallen logs into segments of appropriate lengths;

2. removing material from each segment to provide parallel flat surfaces called flats having widths in a range of ¼ to ¾ of the diameter of the segment, producing a part called a cant;

3. sawing at least one lengthwise, radial slit in each cant with slit depth in a range of ⅛ to ⅜ of the diameter of the cant, 8 slits being preferred;

4. kiln drying the cants;

5. filling at least portions of the slit(s) with material having qualities similar to the qualities of the cants;

6. selecting pluralities of cants, each plurality being comprised of cants having diameters differing no more than a designated amount, said amount being in a range of 0 to 2 inches;

7. joining at least two cants from one plurality together.

In alternate embodiments of the method, steps 3, 4 and 5 may be omitted. If step 4 is omitted, step 5 is also. Step 5 can be omitted independently. The embodiment omitting all three comprises the steps of:

1. cutting fallen logs into segments of appropriate lengths;

2. removing material from each segment to provide parallel flat surfaces called flats having widths in a range of ¼ to ¾ of the diameter of the segment, producing a part called a cant;

3. selecting pluralities of cants, each plurality being comprised of cants having diameters differing no more than a designated amount;

4. Joining at least two cants from one plurality together flat-to-flat;

In an alternate embodiment of the described method, a step is added, the step being cutting one of the cants to be joined in half lengthwise with the cut parallel to the flats of the cant. This step is inserted between the selecting and joining steps.

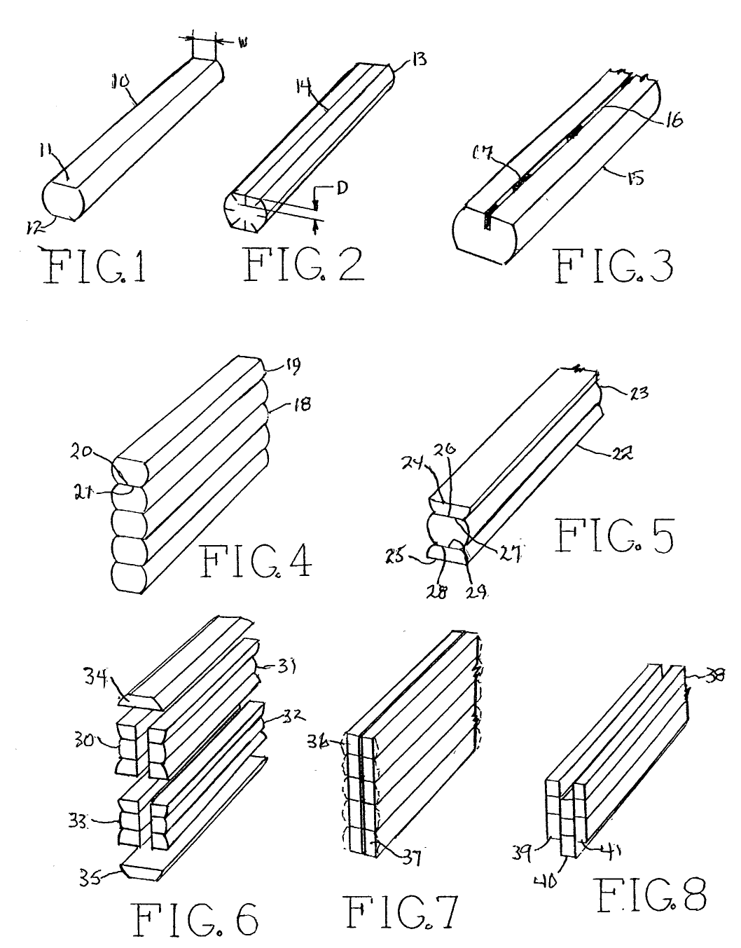

FIG. 1 illustrates a cant 10 as produced in step 2 of the method, having flats 11 and 12. Flat widths, width W being typical, are in a range of ¼ to ¾ of the diameter of the cant. FIG. 2 illustrates a cant 13 having slits, slit 14 being typical, cut radially and lengthwise to relieve stresses in green wood. There may be one or more slits, depending on the judgment of the processor. The depth of the slits, slit D being typical, is in a range of ⅛ to ⅜ of the diameter of the cant. Alternately the cant may be penetrated in a plurality of places, to sever the grain to relieve strain. Slitting and penetrating (aerating) also facilitate kiln drying, reducing the cost considerably. FIG. 3 illustrates a cant 15 with a slit 16 partially refilled, refill portion 17 being typical. The slits may be completely refilled or partially with refill portions evenly spaced or concentrated in areas likely to be more heavily loaded in use.

FIG. 4 illustrates what is termed, for purposes of this disclosure, a product 18, comprising a plurality of cants, cant 19 being typical, glued together, flat-to-flat, flats 20 and 21 being typical. The cants may be dried or not, slit or not and, if slitted, refilled or not.

FIG. 5 illustrates a product 22 produced by an alternate embodiment of the basic method. It comprises a cant 23 and two half cants 24 and 25 made by sawing a cant in half lengthwise with the cut parallel to the flats. The cant and halved cants are glued together, flat-to-flat, flats 26, 27, 28 and 29 being typical.

FIG. 6 is an exploded view illustrating four beams 30, 31, 32 and 33 cut from a product shown in FIG. 4. Remnants 34 and 35 are available for use in a second product.

FIG. 7 illustrates two planks 36 and 37 cut from an end product, the original outline being shown in phantom lines.

FIG. 7 illustrates a tongue and groove board 38 made of three planks 39, 40 and 41 as shown in FIG. 7.

It is considered to be understandable from this description that the subject invention meets its objective. It provides a method for more efficient use of trees twelve inches or less in diameter, the method specifically being lower labor intensive and requiring fewer planing, slitting, sawing and gluing steps required to produce end products to particular standards of quality and quantity. The lower labor intensity and reduction of processing steps is based on the fact that the primary components of end products are half logs rather than the quarter logs shown in the prior art patents cited above. This fact results in less cutting, planing, slitting and gluing and thereby much less handling, relative to the quality and quantity of end products produced.

It is also considered to be understood that while certain embodiments of the method of the subject invention are disclosed herein, other versions of the method are possible within the scope of the invention which is limited only by the attached claims.

I claim:

1. A method for more efficient use of trees twelve inches or less in diameter, said method comprising the steps of:
1. cutting fallen logs into segments of appropriate lengths;
2. removing material from each segment to provide parallel flat surfaces called flats having widths in a range of ¼ to ¾ of the diameter of the segment, producing a part called a cant, said cant having qualities;
3. selecting pluralities of cants, each of said pluralities being comprised of cants having diameters differing no more than a designated amount, said amount being in a range of 0 to 2 inches;
4. selecting at least two of said cants from one of said pluralities;
5. joining said at least two cants together lengthwise, flat-to-flat.

2. The method of claim 1 further comprising the step of sawing at lest one lengthwise, radial slit in each cant with slit depth in a range of ⅛ to ⅜ of diameter of the cant, as follows:
1. cutting fallen logs into segments of appropriate lengths;
2. removing material from each segment to provide parallel flat surfaces called flats having widths in a range of ¼ to ¾ of the diameter of the segment, producing a part called a cant, said cant having qualities;
3. selecting pluralities of cants, each of said pluralities being comprised of cants having diameters differing no more than a designated amount, said amount being in a range of 0 to 2 inches;
4. selecting at least two of said cants from one of said pluralities;
5. joining said at least two cants together lengthwise, flat-to-flat.

3. The method of claim 1, further comprising the step of kiln drying the cants, as follows:
1. cutting fallen logs into segments of appropriate lengths;
2. removing material from each segment to provide parallel flat surfaces called flats having widths in a range of ¼ to ¾ of the diameter of the segment, producing a part called a cant, said cant having qualities;
3. selecting pluralities of cants, each of said pluralities being comprised of cants having diameters differing no more than a designated amount, said amount being in a range of 0 to 2 inches;
4. selecting at least two of said cants from one of said pluralities;
5. joining said at least two cants together lengthwise, flat-to-flat.

4. The method of claim one further comprising the steps of sawing at least one radial slit in each cant with slit depth in the range of ⅛ to ⅜ of the diameter of the cant and kiln drying the cants, as follows:
1. cutting fallen logs into segments of appropriate lengths;
2. removing material from each segment to provide parallel flat surfaces called flats having widths in a range of ¼ to ¾ of the diameter of the segment, producing a part called a cant, said cant having qualities . . .
3. selecting pluralities of cants, each of said pluralities being comprised of cants having diameters differing no more than a designated amount, said amount being in a range of 0 to 2 inches;
4. selecting at least two of said cants from one of said pluralities;
5. joining said at least two cants together lengthwise, flat-to-flat.

5. The method of claim 2 further comprising the step of filling at least portions of the slits with material having qualities similar to said qualities of said cants, as follows:
1. cutting fallen logs into segments of appropriate lengths;
2. removing material from each segment to provide parallel flat surfaces called flats having widths in a range of ¼ to ¾ of the diameter of the segment, producing a part called a cant, said cant having qualities;
3. selecting pluralities of cants, each of said pluralities being comprised of cants having diameters differing no more than a designated amount, said amount being in a range of 0 to 2 inches;
4. selecting at least two of said cants from one of said pluralities;
5. joining said at least two cants together lengthwise, flat-to-flat.

6. The method of claim 4 further comprising the step of filling at least portions of the slits with material having qualities similar to said qualities of said cants, as follows:

7. A method for more efficient use of trees twelve inches or less in diameter, said method comprising the steps of:
1. cutting fallen logs into segments of appropriate lengths;
2. removing material from each segment to provide parallel flat surfaces called flats having widths in a range of ¼ to ¾ of the diameter of the segment, producing a part called a cant;
3. sawing at least one lengthwise, radial slit in each cant with slit depth in a range of ⅛ to ⅜ of the diameter of the cant;
4. kiln drying the cants;
5. filling at least portions of the slits with material having qualities similar to said qualities of the cants;
6. selecting pluralities of cants, each of said pluralities being comprised of cants having diameters differing no more than a designated amount, said amount being in a range of 0 to 2 inches;
7. selecting at least two of said cants from one of said pluralities;
8. joining said at least two flats together lengthwise, flat-to-flat.

8. The methods of claims 1, 2, 3, 4, 5, 6 and 7, each further comprising the step of sawing one of said at least two cants in half lengthwise with the cut parallel to said flats, this step being performed just prior to the step in each claim of joining said at least two flats together lengthwise, flat-to-flat.
